(19) United States
(12) Patent Application Publication
(10) Pub. No.: US 2015/0122245 A1
(43) Pub. Date: May 7, 2015

(54) TWO STEP OPTIMIZATION FOR LIQUEFACTION OF BIOMASS

(71) Applicant: REAC FUEL AB, 223 63 LUND (SE)

(72) Inventors: Haukur Jóhannesson, Lund (SE); Andreas Gram, Hoor (SE); Anders Carlius, Lund (SE); Göran Karlsson, Helsingborg (SE)

(73) Assignee: REAC FUEL AB, 223 63 LUND (SE)

(21) Appl. No.: 14/397,805

(22) PCT Filed: Apr. 30, 2013
(86) PCT No.: PCT/SE2013/050478

§ 371 Date: Oct. 29, 2014

Related U.S. Application Data
(60) Provisional application No. 61/640,070, filed on Apr. 30, 2012.

(30) Foreign Application Priority Data
Apr. 30, 2012 (SE) 1250429-6

(51) Int. Cl. C13K 1/02; C07G 1/00; C13K 1/04

(52) U.S. Cl. CPC C13K 1/02; C13K 1/04; C07G 1/00
USPC 127/37; 530/500

(57) ABSTRACT

The present invention describes a process involving liquefaction of a biomass slurry by treatment in hot compressed water (HCW), said process comprising: —a first decomposition step being performed at an average pH level of at most 4.5, wherein a hemicellulose fraction in the biomass slurry is decomposed to water soluble mono- and/or oligomers, and wherein a cellulose fraction undergoes a pre-treatment for decrystallization of the cellulose polymer; —a separation step; and —a second decomposition step, wherein the cellulose fraction in the biomass slurry is decomposed to water soluble mono- and/or oligomers; wherein both of the first and second decomposition steps are performed at sub-critical temperatures implying relatively moderate conditions.

### FIELD OF THE INVENTION

The present invention relates to a process involving liquefaction of a biomass slurry by treatment in hot compressed water (HCW), said process comprising an optimised two-step decomposition in terms of moderate treatment and high yield of monomers, such as glucose.

### TECHNICAL BACKGROUND

Continuous flow processes for liquefaction of biomass feedstocks exist today. Inter alia US 2010/0184176 A1 discloses a method for biomass hydrothermal decomposition, which method includes feeding biomass material under normal pressure to under increased pressure, allowing the fed biomass material to be gradually moved inside a device main body from either end thereof in a consolidated condition and allowing hot compressed water (HCW) to be fed from another end of a feed section for the biomass material into the main body, so as to cause the biomass material and the hot compressed water to counter-currently contact with each other and undergo hydrothermal decomposition, eluting a lignin component and a hemicellulose component into the hot compressed water, so as to separate the lignin component and the hemicellulose component from the biomass material, and discharging, from the side where the hot compressed water is fed into the device main body, a biomass solid residue under increased pressure to under normal pressure.

Furthermore, separation of cellulose in hot compressed water is also performed today. For instance, it is known from US 2010/0175690 A1 to hydrolyze cellulose and/or hemicelluloses contained in a biomass into monosaccharides and oligosaccharides by using high-temperature and high-pressure water in a subcritical condition. The application provides a method comprising hydrolytic saccharification of a cellulosic biomass with use of plural pressure vessels, the method comprising a charging step, a heating-up step, a hydrolyzing step, a temperature lowering step, and a discharging step, which are performed sequentially by each of said pressure vessels. According to the method, said hydrolyzing step may be performed at a temperature of not lower than 140° C. and not higher than 180° C. to hydrolyze hemicellulose into saccharides. Moreover according to the method, said hydrolyzing step may be performed at a temperature of not lower than 240° C. and not higher than 280° C. to hydrolyze cellulose into saccharides. The two different temperature ranges may be used in one process sequence. The system shown in US 2010/0175690 A1 is a sequencing batch system. As mentioned in US 2010/0175690, the time needed for different steps, such as for loading, and the actual reaction time is long, e.g. above 5 minutes for each step.

Many biomass feedstocks contain valuable components, and one problem with existing techniques is that the refining of the biomass feedstock to valuable products is not optimized. One aim of the present invention is to provide a method which is optimized in terms of fractionation, separation and collecting of valuable components from a biomass feedstock, especially a lignocellulosic feedstock. Moreover, another purpose of the present invention is to provide a method giving high yields of valuable product components, which method is fast in comparison to known methods and which method does not impose severe stresses on the equipment used in the process.

### SUMMARY OF THE INVENTION

The stated purposes above are achieved by a process involving liquefaction of a biomass slurry by treatment in hot compressed water (HCW), said process comprising:
a first decomposition step being performed at an average pH level of at most 4.5, wherein a hemicellulose fraction in the biomass slurry is decomposed to water soluble mono- and/or oligomers, and wherein a cellulose fraction undergoes a pre-treatment for decrystallization of the cellulose polymer;
a separation step; and
a second decomposition step, wherein the cellulose fraction in the biomass slurry is decomposed to water soluble mono- and/or oligomers;
   wherein both of the first and second decomposition steps are performed at sub-critical temperatures implying relatively moderate conditions.

As mentioned above, there are existing two-step processes for biomasses today. For instance in CN101613377 there is disclosed a method for degradation of cellulose to monomers by a process involving two steps: one first step at super-critical conditions where the degradation of the cellulose is performed to oligomers, and then one second step at sub-critical conditions where a further degradation to monomers is performed. First and foremost, there is no separation performed after the first step according to CN101613377. The separation according to the present invention is performed to avoid continued degradation of valuable liquid components, and is thus essential to optimize the biomass liquefaction process. Second, the suggested temperatures according to CN101613377 imply a temperature at super-critical condition in the first step. According to the present invention both steps are performed at a sub-critical condition implying relatively moderate conditions (for both biomass and equipment used). Moreover, the decomposition in the first step according to the present invention allows for both decomposition of hemicellulose without driving the process too far, and also for a pre-treatment of the cellulose so that these are easier to decompose at a moderate condition in the subsequent second decomposition step. The process according to the present invention is as such optimal for increasing the yield of monomers (and oligomers) in the final step as well as for giving a moderate treatment.

Moreover, in “Hydrothermal dissolution of willow in hot compressed water as a model for biomass conversion”, Hashaikeh, R. et al, there is disclosed the dissolution of willow as a model system for biomass conversion in the 200-350° C. temperature range. The dissolution process was studied using a batch-type (diamond-anvil cell) and a continuous flow process reactor. A 95% dissolution of willow was achieved. The lignin and hemicellulose in willow were fragmented and dissolved at a temperature as low as 200° C. and a pressure of 10 MPa. Cellulose dissolved in the 280-320° C. temperature range. A two-step dissolution process was tested in the model system. However, the process disclosed in “Hydrothermal dissolution of willow in hot compressed water as a model for biomass conversion”, Hashaikeh, R. et al, does not involve a first decomposition step being performed at an average pH level of at most 4.5 in which a hemicellulose fraction in the biomass slurry is decomposed to water soluble mono- and/or oligomers and where a cellulose fraction undergoes a pre-treatment for decrystallization of the cellulose polymer such as according to the present invention.

Moreover, in “Some Recent Advances in Hydrolysis of Biomass in Hot-Compressed Water and Its Comparisons with Other Hydrolysis Methods”, Yu, Y. et al, there is disclosed that a two-stage hydrolysis of biomass in HCW is a preferable method. The method is compared to other technologies in the articles, such as acid hydrolysis, alkaline hydrolysis and enzymatic hydrolysis. Also in this case, the process disclosed in the article does not involve a first decomposition step being performed at an average pH level of at most 4.5 in which a hemicellulose fraction in the biomass slurry is decomposed to water soluble mono- and/or oligomers and where a cellulose fraction undergoes a pre-treatment for decrystallization of the cellulose polymer such as according to the present invention.

Furthermore, in “Effect of acetic acid addition on chemical conversion of woods as treated by semi-flow hot-compressed water”, Phaiboonsilpa, N. et al, there is presented a two-step semi-flow HCW treatment with 1 wt % AcOH (acetic acid) at 210° C./10 MPa/15 min (1^{st} stage) and 260° C./10 MPa/15 min (2^{nd} stage). The investigation showed that the temperature may be decreased somewhat in the presence of acetic acid. As mentioned above, the present invention is directed to a process involving a first decomposition step being performed at an average pH level of at most 4.5 where a hemicellulose fraction in the biomass slurry is decomposed to water soluble mono- and/or oligomers, and where a cellulose fraction undergoes a pre-treatment for decrystallization of the cellulose polymer, a separation step, and a second decomposition step, wherein the cellulose fraction in the biomass slurry is decomposed to water soluble mono- and/or oligomers. This is not shown or hinted in “Effect of acetic acid addition on chemical conversion of woods as treated by semi-flow hot-compressed water”, Phaiboonsilpa, N. et al.

Another two-step process is disclosed in “Two-step hydrolysis of Japanese cedar as treated by semi-flow hot-compressed water”, Phaiboonsilpa, N. et al. The process involves a two-step hydrolysis of Japanese cedar (Cryptomeria japonica) by treatment in semi-flow hot-compressed water at 200° C./10 MPa for 15 min and 280° C./10 MPa for 30 min as first and second stages, respectively. At the first stage, hemicelluloses and paracrystalline cellulose, whose crystalline structure is somewhat disordered is said to be selectively hydrolyzed, as well as lignin decomposition whereas crystalline cellulose occurred at the second stage. In all, 87.76% of Japanese cedar could be liquefied by hot-compressed water and was primarily recovered as various hydrolyzed products, dehydrated, fragmented, and isomerized compounds as well as organic acids in the water-soluble portion. This process does not involve a separation step as according to the present invention. Moreover, the first step according to the present invention involves a first decomposition step being performed at an average pH level of at most 4.5 in which a hemicellulose fraction in the biomass slurry is decomposed to water soluble mono- and/or oligomers and where a cellulose fraction undergoes a pre-treatment for decrystallization of the cellulose polymer. This is not the case in “Two-step hydrolysis of Japanese cedar as treated by semi-flow hot-compressed water”.

Furthermore, in “Two-step hydrolysis of nipa (Nypa fruticans) frond as treated by semi-flow hot-compressed water”, Phaiboonsilpa, N. et al, a two-step hydrolysis of nipa (Nypa fruticans) frond, one of the monocotyledonous angiosperms, was studied in a semi-flow hot-compressed water treatment at 230° C./10 MPa/15 min (first stage) and 270° C./10 MPa/30 min (second stage). Also here there is not shown or hinted a first decomposition step being performed at an average pH level of at most 4.5 in which a hemicellulose fraction in the biomass slurry is decomposed to water soluble mono- and/or oligomers and where a cellulose fraction undergoes a pre-treatment for decrystallization of the cellulose polymer, such as according to the present invention. This is also the case of the article “Fractionation and solubilization of cellulose in rice hulls by hot-compressed water treatment, and production of glucose from the solubilized products by enzymatic saccharification”, Kumagai et al, which does not show or hint a first step as according to the present invention. The same is also valid for the process disclosed in EP2075347 A1, which document shows a method and system for hydrolyzing cellulose and/or hemicellulose contained in a biomass into monosaccharides and oligosaccharides by using high-temperature and high-pressure water in a subcritical condition.

Furthermore, WO2011091044 A1 discloses methods for the continuous treatment of biomass comprising a pretreatment step, wherein said biomass is contacted with a first supercritical, near-critical, or sub-critical fluid to form a solid matrix and a first liquid fraction; and a hydrolysis step, wherein said solid matrix formed in said pretreatment step is contacted with a second supercritical or near-supercritical fluid to produce a second liquid fraction and a insoluble lignin-containing fraction. Although acids may be used according to WO2011091044 A1, this is intended in subsequent steps or in other type of steps when compared to the present invention. In WO2011091044 A1 there is not shown a process as according to the present invention involving a first decomposition step being performed at an average pH level of at most 4.5, wherein a hemicellulose fraction in the biomass slurry is decomposed to water soluble mono- and/or oligomers, and wherein a cellulose fraction undergoes a pre-treatment for decrystallization of the cellulose polymer; a separation step; and a second decomposition step, wherein the cellulose fraction in the biomass slurry is decomposed to water soluble mono- and/or oligomers; and wherein both of the first and second decomposition steps are performed at sub-critical temperatures implying relatively moderate conditions.

### SPECIFIC EMBODIMENTS OF THE PRESENT INVENTION

As hinted above, the present invention implies a first step which both decomposes the hemicellulose to oligomers and monomers, of which some are not intended to undergo further decomposition and as such has to be separated off before further decomposition, and as well as subjects the cellulose fraction to a pre-treatment before the second decomposition step. The beneficial effect of the pre-treatment is related to the physic-chemical properties of cellulose. Cellulose having a high degree of micro-crystallinity is difficult to break-down. This is not the fact for hemicellulose. The process according to the present invention renders a pre-treatment of the cellulose, enabling easier decomposition in a subsequent step. This is facilitated by a modification of the cellulose matrix, which might be due to reduction of crystallinity or spatial separation of the cellulose microfibrils. Therefore, according to one specific embodiment of the present invention, the pre-treatment of the cellulose fraction in the first decomposition step implies that the cellulose matrix is converted to a less rigid structure.

The temperature and the process times are important parameters according to the present invention for optimization of yield. According to one specific embodiment of the present invention, the second decomposition step is performed at a higher average temperature than the first decomposition step. Furthermore, according to yet another specific embodiment, the second decomposition step is performed at a higher average temperature than the first decomposition step and wherein the first decomposition step is performed at an average temperature of 200-270° C. and the second decomposition step is performed at an average temperature of 250° C.-340° C. One suitable example is where the first decomposition step is performed at a temperature of 230-260° C. and the second decomposition step is performed at a temperature of 300° C.-340° C. This may also be compared to the suggested temperatures in “Two-step hydrolysis of Japanese cedar as treated by semi-flow hot-compressed water”, Phaiboonsilpa, N. et al which are considerably lower. This should also be one likely reason to why the crystallinity of the cellulose does not seem to be decreased in the first step according to “Two-step hydrolysis of Japanese cedar as treated by semi-flow hot-compressed water”. In relation to this it may also be mentioned that the processing time according to the present invention are intended to be considerably shorter than suggested in “Two-step hydrolysis of Japanese cedar as treated by semi-flow hot-compressed water”. According to one specific embodiment of the present invention, the first decomposition step is performed at a temperature of 230-260° C. during a time of from 5 to 30 seconds and the second decomposition step is performed at a temperature of 300° C.-340° C. during a time of 2-10 seconds. Also the yield should be discussed in relation to the processing parameters. According to the present invention, the yield in the first decomposition step may be at least above 70%, such as above 80%, such as at 85-95%, even above 95%, with reference to the water soluble hemicelluloses sugars. Moreover, the yield in the second decomposition is according to the present invention possible to hold above 40%, even above 50% and as high as 60% and above with respect to water soluble cellulose sugars. Therefore, the present invention renders it possible to achieve a monomer fraction of water soluble carbohydrates from the first and second decomposition steps which are above 40%, above 50%, and which may be considerably higher than that, as shown in the experiments below.

As said, the process according to the present invention comprises an intermediate separation step. According to one specific embodiment, the separation step involves filtration, sedimentation and/or decantation. It should be mentioned that other types of separation techniques are also possible to use, e.g. centrifugation. The separation step may as an example be performed by separating off a liquid phase containing oligomers and monomers (from decomposition of the hemicellulose) not intended to be further decomposed. The solid phase comprising the cellulose is processed to the second decomposition step. In relation to this it may be said that the actual processing equipment may vary according to the present invention. For instance, the first and second decomposition steps may be performed in different reactors where separation (filtration) is made in between. This is of course especially valid for continuous systems according to the present invention. For possible batch systems, the present invention and its two decomposition steps may be performed in one and the same reactor as long as a separation has been performed. A continuous system, e.g. comprising tube reactors, is an interesting alternative according to the present invention.

With respect to the separation step it should also be mentioned that a temperature decrease may be performed before or in connection with this step. This may be of advantage to prevent continued decomposition of water soluble sugar monomers from the hemicellulose fraction. According to one interesting embodiment, the cooling of the produced solution from the first decomposition step is performed before the separation step. This may be of interest to make sure to lower the temperature as fast as possible. The cooling may also be performed at the separation or after, however, as the separation normally takes more time than the quick decomposition reactions, cooling before the separation constitutes a very interesting choice according to the present invention. This is, however, in much affected on other parameters, such as the temperature before cooling, separation technique, etc.

According to one specific embodiment of the present invention, if a lignocellulosic biomass is processed, the lignin may follow the cellulose fraction to the second decomposition step. In such cases, the lignin, which is a clogging component, may have to be taken care of. This may for instance be performed by washing the cellulose before the second step so that lignin may be extracted. Another possibility is to use additives for affecting the lignin in terms of its clogging property or so that it is easier to separate away. One example is dispersing agents.

Furthermore, according to the present invention, the choice of processing may also affect other parameters. For instance, according to one specific embodiment, additional HCW or steam is added to the remaining biomass slurry before the second decomposition step. If a solid phase is collected after a filtration, this solid phase should of course be decomposed in HCW or steam in the second decomposition step. Such HCW or steam may be added directly into a second reactor or before such reactor. The added HCW and/or steam functions as a solvent as well as heating substance.

Besides temperature and time, also the pH value is an important parameter according to the present process. According to the present invention, the first decomposition step is performed at an average pH level of at most 4.5, such as between 4 and 4.5, e.g. below 4.2. The biomass slurry going into the first decomposition step may e.g. have a pH value of 4-6, but it can also be lower.

According to one specific embodiment of the present invention, a pH lowering additive is added in the process and the pH level of the solution is in the range of 1.0-3.5 after such addition of a pH lowering additive. For instance, a pH value of just above 1.0, such as about 1.3, may be achieved by the addition of sulphuric acid (around 0.5%).

The intended pH value in the process depends on several parameters, such as the biomass composition, chosen temperature, etc, etc.

It should be said that the pH level is not normally forced to be held at a constant level, so the pH level of the solution going out from the first decomposition step is lower than the pH level of the biomass slurry fed to this first step. In relation to this it should further be mentioned that organic acid, e.g. acetic acid, is produced in the process, which acid as such lowers the pH level and may also function as a driver for the decomposition as such. It should further be said that it is also possible according to the present invention that a low pH is used in the process, which is driven by the addition of a comparatively strong acid, and that the pH going out from e.g. the first step is higher caused by the production a comparatively weaker acid.

Acids may also be added into the system. According to one embodiment, a pH lowering additive is added before the first decomposition step. Such acids may be added in the process at different points. Moreover, both organic and inorganic acids may be of interest. For instance, sulphuric acid is one example that is suitable to add already before or in the first decomposition step. In relation to acids, and as hinted above, it is also possible according to the present invention to use the naturally produced acids in the process. Therefore, according to one specific embodiment, acids produced are recirculated in the process. This may ensure that extra acids do not have to be added, however also a combination of addition and recirculation is possible according to the present invention.

The process according to the present invention may also comprise other steps. For instance, to incorporate subsequent flashing steps is one suitable way for quenching the reactions so that further unwanted decomposition is not continued after the liquefactions. Therefore, according to one specific embodiment of the present invention, the process also involves a flash step(s), performed after the first decomposition step and/or after the second decomposition step, to reduce the temperature to about 200° C. or below in order to prevent continued decomposition and/or to increase the yield. As notable, the flash step may be performed after either the first or second decomposition steps, or after both of them.

Flash cooling is normally performed in several steps according to the present invention. As an example, the first flash or quench may be performed to a temperature of e.g. below 220° C., such as below 215° C. but above 200° C., while a second flash may be made to a temperature of around 150° C., such as in the range of 130-170° C. This second flash may transform dissolved lignin to solid quickly without risking clogging or fouling. This residual solid may then be removed from the product solution by a separation technique.

It should clearly be stated that the flashing may be performed in just one step also, such as directly to a temperature of e.g. 150° C., according to the present invention to achieve an effective quenching step allowing for subsequent lignin removal. However, from an energy efficiency point of view several steps may be beneficial.

As hinted above, the process according to the present invention is preferably performed in a continuous flow system, such as a tube, however the principle may also be used for batch or semi-batch systems. Also processes in such systems are embodied by the present invention.

Moreover, according to yet another specific embodiment of the present invention, the process also involves a post-hydrolysis step where existing oligomers are converted to monomers. The process according to the present invention may as such involve a flash-step to reduce the temperature to 220° C. or below in order to prevent continued decomposition and/or a post-hydrolysis step where the oligomers are converted to monomers. In this sense, it may be mentioned that at industrial scale, the residence time in a flash-tank is of the order of a few minutes which may pose a problem with respect to the formation of by-products. However, the post-hydrolysis also requires a few minutes at 200° C. for optimal yield. It is thus possible to find a compromise in residence time which combines the requirements for the flash-step with the post-hydrolysis, without resulting in excessive by-product formation and at the same time achieving high monomer yields.

As mentioned above, additives may be used according to the present invention. One example is one or several dispersing agents for making e.g. the lignin easier to handle. This may for instance be very interesting for the second step as the lignin follows the solid phase to the second decomposition step. As understood from above, according to one embodiment of the present invention, the biomass is a lignocellulosic biomass. Therefore, the present process may also comprise treating and/or collecting a lignin fraction from the biomass slurry.

### EXAMPLES

Spruce was decomposed using a three-step process. First a hemi-step process was employed, where most of the hemicelluloses were solubilized. Second, a post-processing was performed at conditions that are similar to the conditions in a flash tank. Third, after decantation and filtration the remaining filter cake was processed at higher temperatures in order to solubilize the cellulose.

Spruce, grounded to 200 μm, was mixed with water to form a slurry. The fraction of biomass in the slurry was 8% by weight. Two different processing temperatures and residence times were used for the initial hemi-step (see table 1).

The processed slurry was post-processed at a lower temperature of ˜200° C., with a residence time of ˜100 s (see table 1). After post-processing the solid material was separated from the liquid solution by repeated decanting/washing cycles and finally filtration.

TABLE 1
Process conditions and yields for the two hemi-step samples (#1 & #2),
and the corresponding samples after post-processing (#3 & #4).

| | | | | | Yield of water |
|---|---|---|---|---|---|
| | | | | | soluble |
| | Temperature | Residence | | | hemicelluloses |
| Sample | (° C.) | time (s) | pHᵢₙ | pHₒᵤₜ | sugars (%) |
| #1 | 252 | 8.9 | 4.75 | 3.64 | 76.7 |
| #2 | 264 | 5.7 | 4.75 | 3.56 | 76.3 |
| #3 (#1 repr.) | 200 | 111.0 | 3.64 | 3.59 | 93.1 |
| #4 (#2 repr.) | 200 | 110.9 | 3.56 | 3.54 | 97.8 |

After hemi-step processing and post-processing the solids were washed and separated as follows. The solution was decanted and refilled with water to restore the original volume. This was repeated three times, but the third time refilling with water was not performed. The washed filter cake was then used for producing a new slurry of the desired concentration (7-8%). Two different slurries, originating from the two different hemi-step processes were prepared. The slurries were processed at temperatures in the range 302-318° C. The results are shown in table 2. The fraction of sugar monomers originating from the different process conditions is shown In table 3.

TABLE 2
Process conditions and yields for the two slurries originating from
the two hemi-step processing and subsequent post-processing.

| | | | | | Yield of |
|---|---|---|---|---|---|
| | | | | | water soluble |
| | Temperature | Residence | | | cellulose |
| Sample | (° C.) | time (s) | pHᵢₙ | pHₒᵤₜ | sugars (%) |
| #5 (#3 repr.) | 313 | 3.8 | 4 | 3.11 | 48.2 |
| #6 (#3 repr.) | 318 | 3.6 | 4 | 2.96 | 49.5 |
| #7 (#4 repr.) | 302 | 4.0 | 4.12 | 3.35 | 35.2 |
| #8 (#4 repr.) | 308 | 3.7 | 4.12 | 3.16 | 54.2 |
| #9 (#4 repr.) | 313 | 3.5 | 4.12 | 3.07 | 60.4 |

TABLE 3
Monomer fraction of water soluble
carbohydrates from the hemi-step, post-processing-
step, and cellulose step.

| | Monomer fraction of water |
|---|---|
| Sample | soluble carbohydrates (%) |
| #1 | 10.2 |
| #2 | 10.5 |
| #3 (#1 repr.) | 19.2 |
| #4 (#2 repr.) | 17.0 |
| #5 (#3 repr.) | 59.1 |
| #6 (#3 repr.) | 84.4 |
| #7 (#4 repr.) | 43.5 |
| #8 (#4 repr.) | 58.6 |
| #9 (#4 repr.) | 64.3 |

### Discussion

Almost complete solubilization was achieved for the hemicellulose fraction after processing at 250-265° C. and subsequent post-processing at 200° C. The fraction of hemicellulose monomers increased by a factor of two after post-processing.

The yield of water soluble cellulose sugars depends on the conditions used in the first step. This is further supported by other experiments where dilute acid was used in the hemi-step, and which resulted in cellulose yields of 67%, i.e. exceeding the values shown here. In this case small amounts of acid (˜0.02% as measured as percentage in relation to the total slurry and ˜0.2% as measured as percentage in relation to the biomass) in the hemi-step have been found to increase the hemicelluloses yield from 70-75% to 85-90%. The unexpected wanted side-effect was that the break-down of cellulose in the subsequent step was very different from observed in previous experiments. Using relatively modest reaction conditions, i.e. temperature ˜320° C. and residence time ˜2.5 s, very high yields (˜67%) of water soluble mono- and oligomers were produced. Also the production of monomers was much higher than previously observed, constituting more than half of the water soluble sugars. The fraction of monomers, i.e. glucose, is high and could be further improved by subsequent post-processing at a lower temperature.

The findings according to the present invention are not in agreement with previous results obtained for microcrystalline cellulose, or unprocessed biomass, where yields of water soluble mono- and oligomers in the range 40-45% have been obtained. The most plausible interpretation is that the hemi-step, which originally was meant to leave the cellulose intact, has modified the biomass matrix so that it becomes more easily decomposed. The degree of crystallinity of the cellulose has probably been dramatically reduced in the hemi-step, facilitating a more rapid decomposition of the polymer to oligomers and monomers.

1. Process involving liquefaction of a biomass slurry by treatment in hot compressed water (HCW), said process comprising:
a first decomposition step being performed at an average pH level of at most 4.5, wherein a hemicellulose fraction in the biomass slurry is decomposed to water soluble mono- and/or oligomers, and wherein a cellulose fraction undergoes a pre-treatment for decrystallization of the cellulose polymer;
a separation step; and
a second decomposition step, wherein the cellulose fraction in the biomass slurry is decomposed to water soluble mono- and/or oligomers;
wherein both of the first and second decomposition steps are performed at sub-critical temperatures implying relatively moderate conditions.

2. Process according to claim 1, wherein the pre-treatment of the cellulose fraction in the first decomposition step implies that the cellulose matrix is converted to a less rigid structure.

3. Process according to claim 1 or 2, wherein the second decomposition step is performed at a higher average temperature than the first decomposition step.

4. Process according to any of claims 1-3, wherein the second decomposition step is performed at a higher average temperature than the first decomposition step and wherein the first decomposition step is performed at an average temperature of 200-270° C. and the second decomposition step is performed at an average temperature of 250° C.-340° C.

5. Process according to claim 4, wherein the first decomposition step is performed at a temperature of 230-260° C. and the second decomposition step is performed at a temperature of 300° C.-340° C.

6. Process according to claim 4 or 5, wherein the first decomposition step is performed at a temperature of 230-260° C. during a time of from 5 to 30 seconds and the second decomposition step is performed at a temperature of 300° C.-340° C. during a time of 2-10 seconds.

7. Process according to any of claims 1-6, wherein the separation step involves filtration, sedimentation and/or decantation.

8. Process according to any of claims 1-7, wherein a temperature decrease is performed before or in connection with the separation step.

9. Process according to any of the preceding claims, wherein additional HCW or steam is added to the remaining biomass slurry before the second decomposition step.

10. Process according to any of the preceding claims, wherein a pH lowering additive is added in the process and the pH level of the solution is in the range of 1.0-3.5 after such addition of a pH lowering additive.

11. Process according to any of the preceding claims, wherein a pH lowering additive is added before the first decomposition step.

12. Process according to any of the preceding claims, wherein the process also involves a flash step(s), performed after the first decomposition step and/or after the second decomposition step, to reduce the temperature to 220° C. or below in order to prevent continued decomposition and/or to increase the yield.

13. Process according to any of the preceding claims, wherein the process also involves a post-hydrolysis step where existing oligomers are converted to monomers.

14. Process according to any of the preceding claims, wherein a dispersing agent is added.

15. Process according to any of the preceding claims, wherein the biomass is a lignocellulosic biomass.

16. Process according to claim 15, wherein the process also comprises treating and/or collecting a lignin fraction from the biomass slurry.
